(19) United States
(12) Patent Application Publication
(10) Pub. No.: US 2019/0281763 A1
(43) Pub. Date: Sep. 19, 2019

(54) AIR CURTAIN HARVESTER

(71) Applicant: David Hammon, Simi Valley, CA (US)

(72) Inventor: David Hammon, Simi Valley, CA (US)

(21) Appl. No.: 16/297,591

(22) Filed: Mar. 9, 2019

Related U.S. Application Data
(60) Provisional application No. 62/642,494, filed on Mar. 13, 2018.

(51) Int. Cl. A01D 45/30; A01M 5/08

(52) U.S. Cl. CPC A01D 45/30; A01M 5/08

(57) ABSTRACT

A machine for harvesting seeds or insects includes a mechanical compressor, a seed removal device, and an air curtain for directing seeds into troughs below the seed removal device.

### PRIORITY CLAIM

This application claims the benefit of U.S. Provisional patent application 62/642,494 filed Mar. 13, 2018.

### BACKGROUND OF THE INVENTION

The air curtain harvester provides a new and novel way to harvest particles, such as seeds or insects. Harvesting may be from a variety of crops in a manner that reduces use and waste including pesticide use and waste.

### Field of Invention

This invention relates to the mechanical arts. In particular, an air curtain harvester includes rakes, blowers, compression fork, and seed bins.

### Discussion of the Related Art

Harvesters may include means for gathering seeds. But, they typically do not include electric blowers to maintain an air curtain that removes remove loosened seeds prior to blowing them back before they exit the harvester, the blower being particularly arranged between seed bins and the rake and using a compression fork to remove seeds into the seed bin.

### SUMMARY OF THE INVENTION

An air curtain harvester comprises: an inverted “V” shaped mechanical compressor; walls of the compressor parallel to and straddling row crop rows such that the row crops are compressed therebetween; walls of the compressor forming or adjacent to inside walls of two seed troughs; seed removal devices including rakes above the mechanical compressor; the seed troughs having upward facing seed trough mouths; and, powered fans arranged around the seed trough mouths; wherein the fans are operable to generate an air curtain that directs the seeds removed by the seed removal devices into the troughs.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1 shows a front view of the air curtain harvester with air curtain, “V” shaped plant compressor, seed removal blowers, seed trough, and rakes or brooms.

FIG. 2 shows a top view of the air curtain harvester with the “V” shaped plant compressor, seed removal blowers, and seed trough.

FIG. 3 shows a side view of the air curtain harvester with air curtain fans, a seed collection bin or seed trough, seed removal blower(s), and rake(s).

### DETAILED DESCRIPTION OF THE PREFERRED EMBODIMENTS

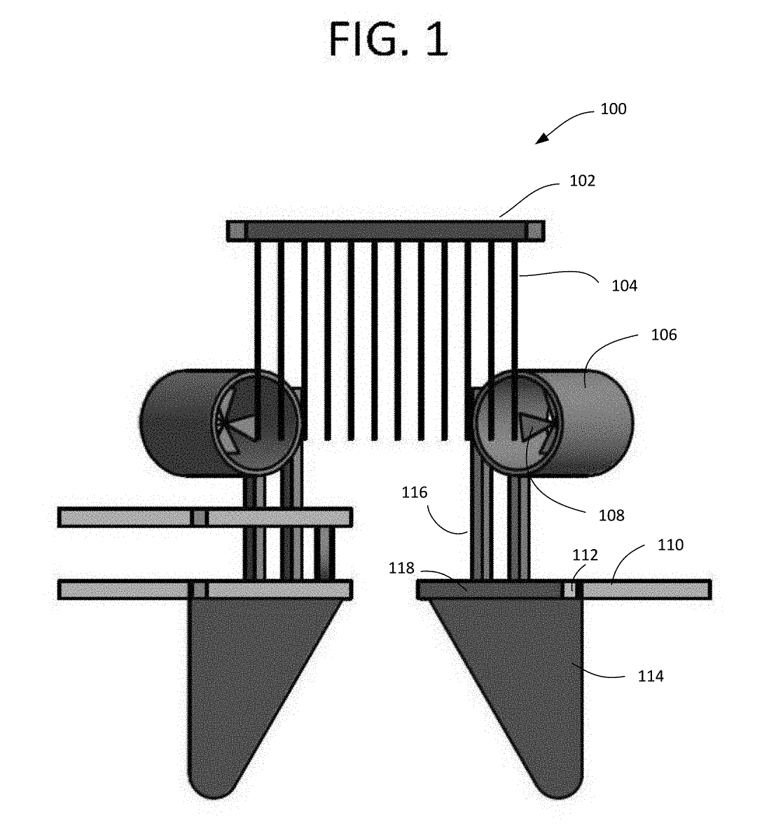

FIG. 1 shows a air curtain front view 100. In the figure, rakes or paddles 104 knock the seeds from plants and a height adjustable bar 102 raises or lowers rakes 104 to adjust for different size plants. An electric blower 106, 108 removes loosened seeds and blow the seeds back before exiting the machine. A height adjustment for the seed blower is provided 116 along with a seed collection bin 114. A compressing fork 118 moves plants into a smaller gap to ensure the air curtain fan blowers prevent seed from falling through. A seed bin holder 110, 112 includes a seed bin for height adjustment for different size plants.

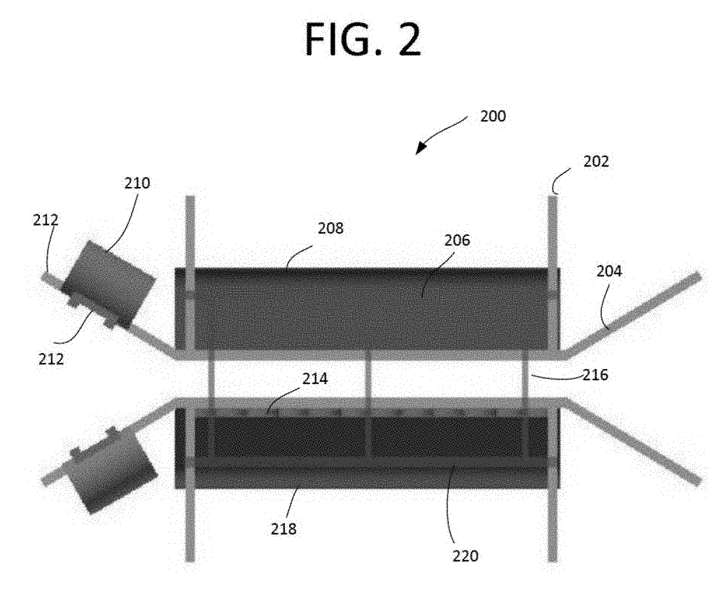

FIG. 2 shows an air curtain top view 200. In FIG. 1 and FIG. 2, rakes or paddles 104 knock the seeds from plants and a height adjustable bar 102, 206, 220, 216 raises or lowers rakes 104 to adjust for different size plants. An electric blower 106, 108, 210 removes loosened seeds and blows the seeds back before exiting the machine. A height adjustment for the seed blower is provided 116, 212 along with a seed collection bin 114, 208, 218. A compressing fork 118, 204 moves plants into a smaller gap to ensure the air curtain fan blowers prevent seed from falling through. An adjustable holder for the blower assembly 212 provides for blower assembly adjustment. A seed bin holder 110, 112, 202 includes a seed bin for height adjustment for different size plants. Blower fans 214 prevent seeds from falling through the compression gap.

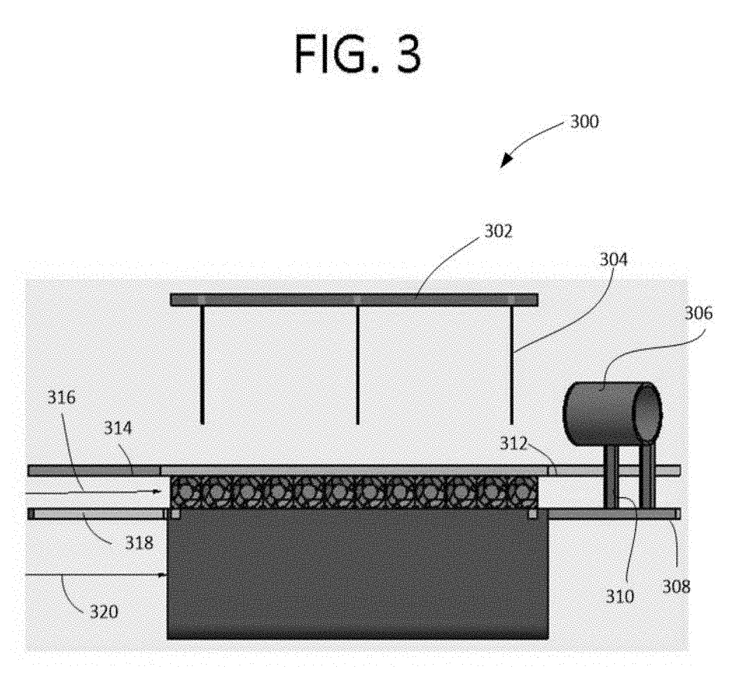

FIG. 3 shows an air curtain side view 300. In FIG. 1, FIG, 2 and FIG. 3, rakes or paddles 104, 304 knock the seeds from plants and a height adjustable bar 102, 206, 220, 216, 302 raises or lowers rakes 104 to adjust for different size plants. An electric blower 106, 108, 210, 306 removes loosened seeds and blows the seeds back before exiting the machine. A height adjustment for the seed blower is provided 116, 212, 310 along with a seed collection bin 114, 208, 218, 320. A compressing fork 118, 204, 314, 318 moves plants into a smaller gap to ensure the air curtain fan blowers prevent seed from falling through. An adjustable holder for the blower assembly 212, 308, 312 provides for blower assembly adjustment. A seed bin holder 110, 112, 202 includes a seed bin for height adjustment for different size plants. Blower fans 214, 316 prevent seeds from falling through the compression gap.

Crops harvested by the air curtain harvester may include those planted in rows including lettuce, flowers, or grasses. Also, plants in native environments, such as natural prairie grasses are candidates for harvesting seed or extracting insects. Items that can be harvested include seeds or other lightweight particles such as insects or ash. The device can be used for example by farmers and organic farmers to collect insects, such as grasshoppers. The device may benefit crops covered in ash, areas that have water shortages, fertile growing grounds left by recent California wildfires, and any combination of these.

In an embodiment, the extraction process of the invention does not damage the plant. Current seed extraction devices sever the plant and extract seed from the severed plant crowns. Crops, such as lettuce, that undergo a second harvest must wait for the severed tops to regrow. With current harvesters, all seeds are collected, both mature and immature. Notably, the mature seeds have much greater value while the immature seeds have lesser value. In some cases immature seeds are discarded altogether.

Embodiments of this invention used for seed collection assure only mature seeds are harvested leaving immature seeds that cling to the plant for collection at a later date. In this way, plants will generate a second crop more quickly.

An embodiment of this invention provides a harvesting machine that either straddles crop rows or moves over native grasses. When the harvesting machine is engaged, a V-shaped compressor, coupled with mini-blowers, corral ready-to-harvest seeds into an enclosed collection area.

As part of the harvesting process, plants are gently compressed toward the middle of the row using a V shape compressor. Using a series of mini-blowers an air current creates a high velocity ‘curtain’ of laminar air that prevents the seed from falling through gaps on the passage to the collection troughs. Simultaneously, a series of raker, brooms, blowers, and brushes loosen the particles (e.g. seeds, insects, ash).

When this process is used for seed collection, the agitation intensity is similar to the way seed is naturally released with gentle massages of the plant tops. When the process is used to collect insects for organic farming purposes or ash following fires, the strength of the blowers may be adjusted to remove the insects or particles without harming the plants. When the troughs have reached capacity, a vacuum transfers the seed to a holding container on the harvester until ready for further processing.

During spraying operations the rakes may be replaced with sprayers for pesticides. The plants are concentrated so a smaller area of spray is needed and less chemicals are used. The sprayers spray the plants only, not the ground. Overspray is avoided so that chemicals are not wasted on surfaces that need no spray. Overspray may be collected in a modified seed trough.

A typical planting uses 40 inch rolls. The plants are placed 16 inches apart (8 inches from center.) if each plant is 12 inches in diameter. The chemical sprayer would spray 28 inch wide stream and 2 inches in the center would go straight to ground. With this machine the center to plant would be compressed to 3 inch. Meaning a 6 inch gap on the rails. Now the sprayer would have an 18 inch spray with no chemicals going straight to ground. All overspray may be collected. Reduction in chemical use may be about 40%.

Embodiments of the invention ensure that the seed is fully mature and ready for harvesting. With proper adjustment of the rakes, vacuums and blowers only the mature seed will fall leaving the younger seeds on the plant to fully develop. Mature seed provide maxim germination when harvested. The percentage of germanium is a cost factor when selling as it is a characteristic of seed quality.

Higher grades of seed correlates to a higher price per pound and another pass through the field in a week or so will collect the new crop of ripe seed.

Currently seed is harvested by cutting both mature and underdeveloped seed during collection. Then there is a wait for the plant to regrow and produce a new crop of seed. But if the immature seed are left to develop and mature they may be harvested in less time that that required for the plant to regrow/recover from cutting both mature and underdeveloped seed.

In organic farming, insects may be removed from the field without chemicals. While removing all the insects from a field does not mean there will not be more the next day, but it does mean the repeated use of collecting insects will reduce damage without hurting the plants

Benefits of the invention disclosed herein include one or more of:
1) plant is not damaged;
2) only mature seeds harvested not fully developed seeds left for future harvest;
3) versatile tractor speed or walking speed;
4) high efficiency, little seed loss;
5) large and small volume single roll or mutable rolls; and,
6) single or double roll can be attached for off road collection of native grasses, flowers and insects.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

1. An air curtain harvester comprising:
an inverted “V” shaped mechanical compressor;
walls of the compressor parallel to and straddling row crop rows such that the row crops are compressed therebetween;
walls of the compressor forming or adjacent to inside walls of two seed troughs;
seed removal devices including rakes above the mechanical compressor;
the seed troughs having upward facing seed trough mouths; and,
powered fans arranged around the seed trough mouths;
wherein the fans are operable to generate an air curtain that directs the seeds removed by the seed removal devices into the troughs.
